(19) United States
(12) Patent Application Publication
(10) Pub. No.: US 2002/0120500 A1
(43) Pub. Date: Aug. 29, 2002

(54) Retail outdoors communication kiosk system

(76) Inventor: DuWayne Johnson, Alexandria, MN (US)

Correspondence Address: Claude T. Anderson, 7595 214th Street, Forest Lake, MN, 55025, US

(21) Appl. No.: 09/795,250

(22) Filed: Feb. 28, 2001

(51) Int. Cl. G06F 17/60

(52) U.S. Cl. 705/14

(57) ABSTRACT

This invention consists of marketing and advertising system for a financial institution's drive-up customers. PC based marketing and advertising messages are broadcast to daylight readable monitors located in kiosks at the drive-up lanes. The marketing software presentation would have a length usually in a range of 3 to 7 minutes and would be continually repeated throughout the day. A marketing consultant would update the marketing software presentation typically on a 30 to 90 day frequency, or longer if desired. The financial institution would be able to directly modify from 0 to 15 percent of the marketing software presentation.

### BACKGROUND OF THE INVENTION

This invention consists of a system to provide marketing, advertising and other information for drive-up customers of financial institutions.

The prior art for financial institution marketing and advertising programs consists of TV and radio advertising, billboards, signs and various print materials. Due to the nature of this advertising it tends to be directed to the public generally rather than to existing bank customers.

Having marketing and advertising communications that can be directed to financial institution customers is often desirable. Financial institutions can present marketing and advertising to customers that enter their building with signs and various types of computer display terminals designed for indoor use. Examples of indoor advertising prior art include U.S. Pat. No. 5,955,710 for elevator messages, and U.S. Pat. No. 6,073,119 issued to Bornemisza-Wahr for a video wall in a financial institution.

Significant portions of the financial institutions customer base do not routinely enter the building, but instead utilize drive-up and other facilities. Examples of drive-up stations include those described by Peters, et al. in U.S. Pat. No 6,164,529 and Vogel et al. in U.S. Pat. No. 5,564,868. A drive-up teller station with an illuminated sign is described by Dallman in U.S. Pat. No. 5,217,088 Prior art drive-up lanes include two-way closed circuit TV (CCTV) that would permit advertising messages to be broadcast to the customers. Marketing and advertising that is directed to drive-up customers has been limited generally to outdoor signs since computer displays for outdoor use have small screens, are text based and do not have graphics capabilities.

There exists a need in the field to provide a system that reaches drive-up customers in a cost effective manner. With the development of daylight readable liquid crystal displays (LCD) as described by Legyel in U.S. Pat. No. 6,172,725 it is possible to provide a marketing and advertising system that can be used to reach a financial institution's drive-up customers as part of integrated marketing and advertising program, which is more effective and less costly than prior-art approaches.

### BRIEF SUMMARY OF THE INVENTION

The overall invention consists of a system containing hardware and software components designed to deliver marketing and advertising communications to customers of financial institutions while they are waiting for their transactions to be processed at drive-up lanes.

Marketing software will be periodically provided to a financial institution for installation on the financial institutions computer and presentation to their drive-up customers. Typically, drive-up lanes are located outdoors, possibly under a roof structure, but generally placed under daylight conditions of high background lighting where a conventional computer display is not readable, therefore not suitable for use. With the present invention, each drive-up lane will include a kiosk having a direct-daylight readable display unit installed. The kiosk will be used to communicate various types of advertising, marketing and other types of information of interest to the financial institutions drive-up customers. This system can be used to coordinate the messages provided to drive-up customers with those provided to customers inside the facility.

The outdoor hardware consists of a kiosk containing a computer LCD monitor in a weather protective enclosure. An important feature of the monitor is that it is “direct-daylight readable” in sunlight conditions. All monitors will be displaying the same message simultaneously at each location. Heating and cooling features are available in the kiosk to control the inside temperature for the LCD monitor. The LCD monitors can be of a variety of sizes, however the most popular sizes are expected to be from 12-inches to 15-inches.

The financial institutions computer will be equipped with technology to display the marketing software presentation through multiple monitors simultaneously. The software can run from the hard drive, CD ROM, or via an Internet connection with broadcast capabilities. The computer hardware will also be available to operate other PC software as appropriate.

The software is customized software for each customer. Generally a marketing consultant will prepare the marketing software presentation for each financial institution. To ensure the quality, timeliness and continuity of the message, the software will typically be licensed to the end-user and not sold. The software will typically be designed to provide a 3 to 7 minute presentation. Periodic updates will be provided to the financial institution to maintain fresh marketing messages. The software will provide the user with the option of controlling a limited number of personalized messages. It is intended that the marketing messages will compliment various marketing and advertising campaigns throughout the year.

It is a primary objective of this invention to provide marketing and advertising communications to customers of financial institutions while they are waiting for their transactions to be processed at drive-up lanes.

It is another objective of this invention to provide a marketing and advertising system to supplement or replace existing mass-market advertising.

It is an additional objective of this invention to provide a marketing and advertising system that will reach financial institution customers that may not often enter the financial institution's building.

It is a further objective of this invention to provide a personal computer based marketing and advertising system that is less costly than conventional media advertising.

It is another objective of this invention to provide a kiosk for each drive-up lane having a display readable under direct-daylight conditions.

It is an additional objective of this invention to provide customized marketing software to each financial institution.

It is a further objective of this invention to provide marketing software that can be periodically modified on a 30 to 90 day schedule.

It is an additional objective of this invention to provide marketing software that can be periodically modified over the internet.

It is another objective of this invention to provide marketing software that can be easily and economically updated by the financial institution with local information as frequently as desired.

It is an additional objective of this invention to provide a computer system that can simultaneously deliver graphically based information to several drive-up customers.

It is a further objective of this invention to provide a marketing and advertising system that will allow a financial institution to sell advertising space.

It is another objective of this invention to provide a marketing and advertising system that will allow a financial institution to include broadcast programming such as a headline news service, stock ticker or weather channel to drive-up customers.

It is an additional objective of this invention to provide a marketing and advertising system that will allow a financial institution to include audio messages with the video communications.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is a flow chart outlining the steps of the invention.

FIG. 2 shows a front perspective view of the kiosk with monitor.

FIG. 3 shows a side perspective view of the kiosk with monitor.

FIG. 4 shows a rear perspective view of the kiosk with monitor.

FIG. 5 is a detail view of the kiosk and monitor.

FIG. 6 is a sample opening screen shot that could be shown to customers.

FIG. 7 is a sample screen shot of a community page.

FIG. 8 is a sample screen shot of a bank announcement.

FIG. 9 is a sample screen shot marketing bank services that could be shown to customers.

FIG. 10 is a sample screen shot marketing bank services that could be shown to customers.

FIG. 11 is a sample screen shot showing bank ATM locations.

FIG. 12 is a sample screen shot marketing bank services that could be shown to customers

### DETAILED DESCRIPTION OF THE INVENTION

The overall invention consists of a retail outdoors communications kiosk, which is an advertising and marketing system that financial institutions such as banks, savings and loans, and credit unions can use to target information to drive-up customers. The invention is described in terms of its applicability to financial institutions, but the invention would have a benefit for other retailers that have drive-up windows for customer contact such as pharmacies, photo developers, fast-food/beverage retailers and automotive service providers such as gas stations, car washes and oil change/service retailers.

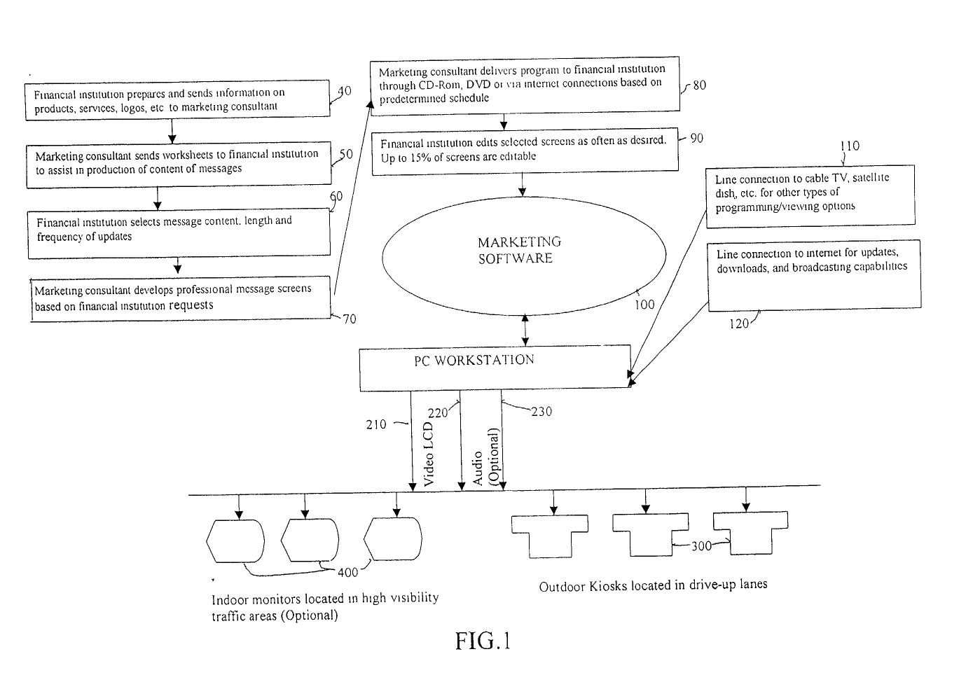

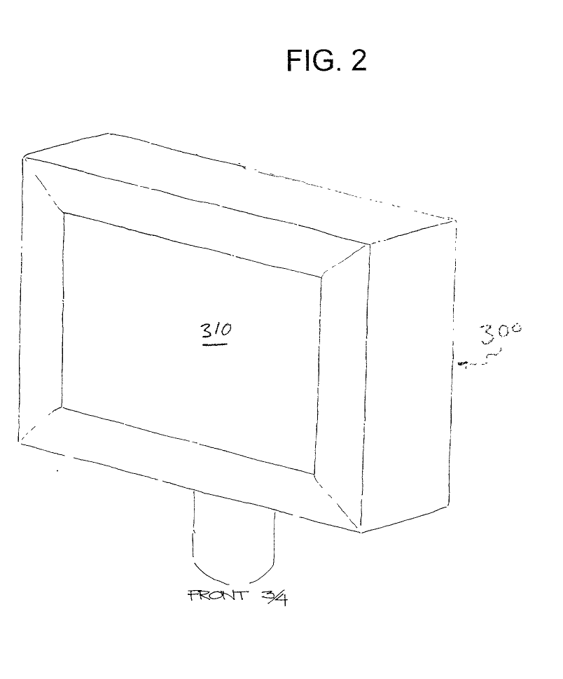

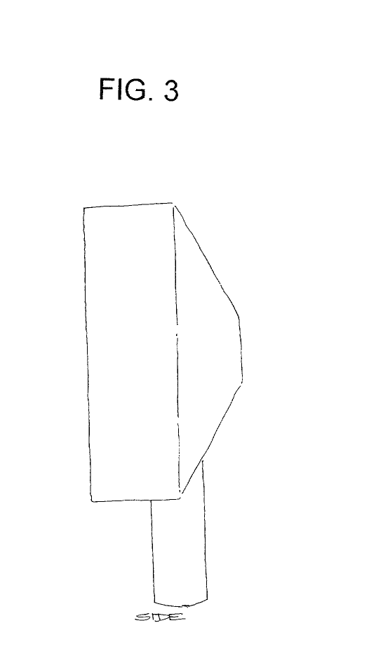

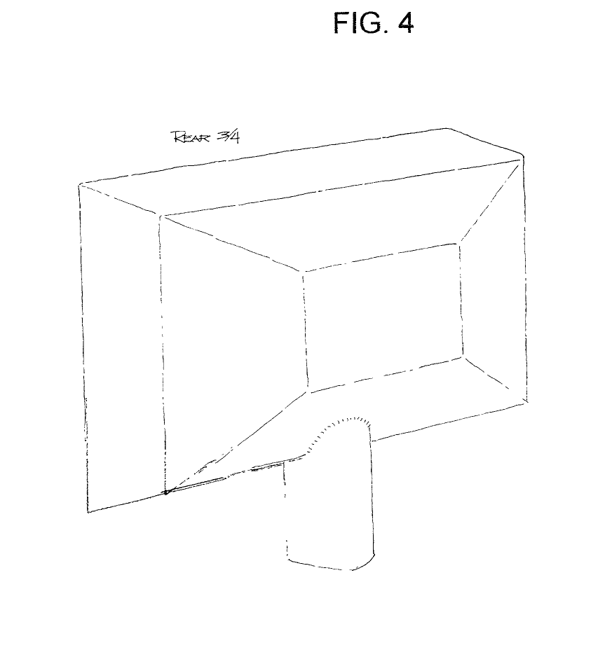

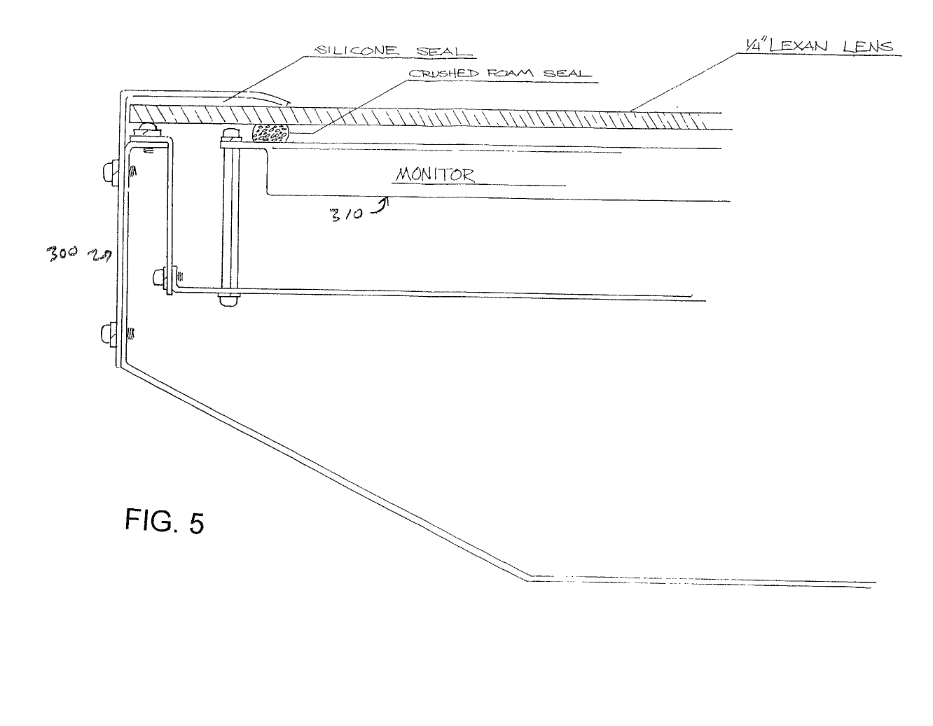

A unique feature of this invention is that regular interaction with the financial institution will occur to determine the content of the software Personalization with corporate logos, product names, marketing themes, etc. will be coordinated between the financial institution and marketing consultant's design team. For example, with this invention it is possible to provide information during the winter season about vacation loan packages in one frame of a screen, while at the same time provide a video clip showing activities at a winter vacation destination. With reference to FIG. 1, to implement this invention, the financial institution prepares and sends information on products, services, logos, etc. to the marketing consultant (40). The marketing consultant then utilizes this information to prepare worksheets that are sent to the financial institution to assist in the production of the content of the messages (50). The financial institution selects content, length and frequency of updates of the message (60). The financial institution will have the option for determining the length of each production. This determination is expected to depend mainly on typical drive-up customer cueing times, the amount of information to the financial institution wants to present, and the cost of producing the messages. The most common length is expected to be 3, 5, or 7 minute productions. There will also be the option of frequency of updates, which for example could be every 30, 60, or 90 days.

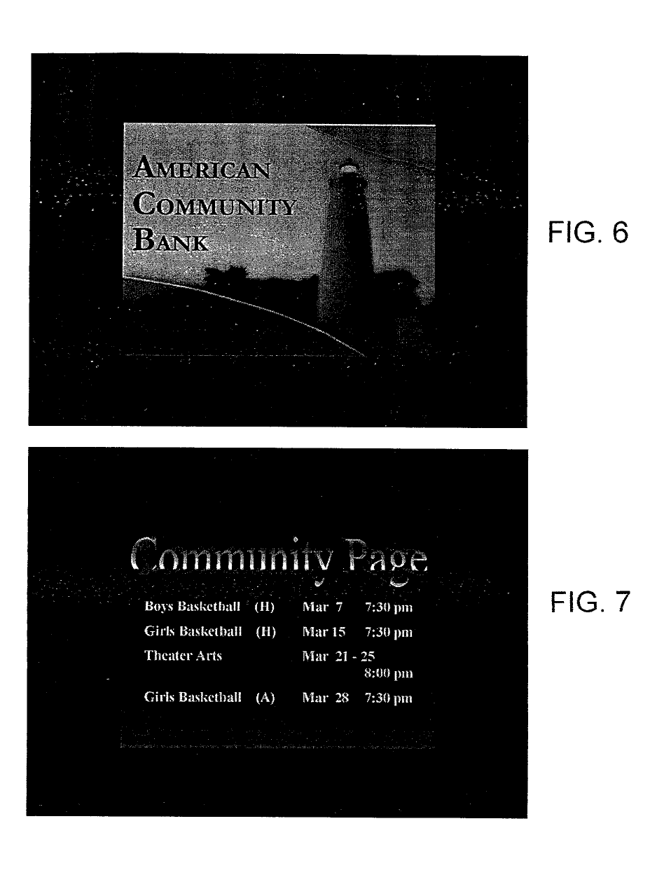

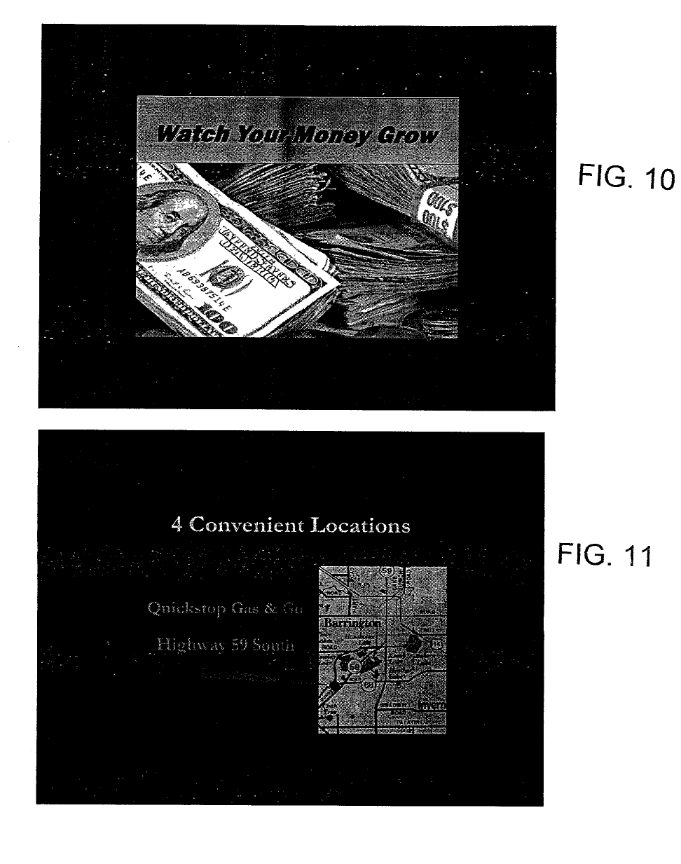

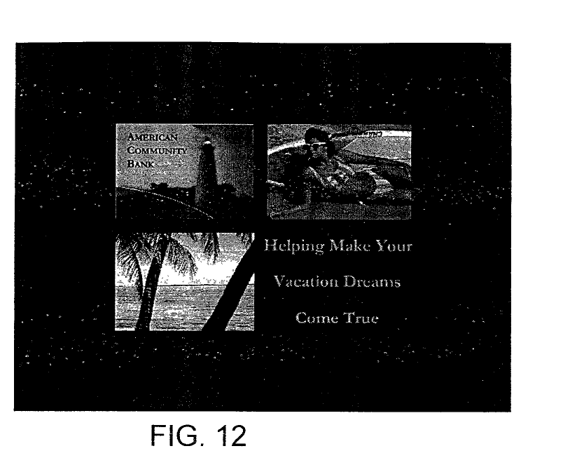

The marketing consultant then develops professional message screens based on financial institution requests (70) for use in the marketing software presentation (100). The marketing software presentation (100) would typically be developed by marketing professionals using computer graphics software packages Examples of currently available software include Macromedia Director™, Microsoft Power Point™, or Microsoft FrontPage™. The marketing software presentation will produce screens that may be divided into one or more windows or frames. This will allow several complementary graphics to be displayed simultaneously. The graphic in a particular frame or window providing information about a particular financial institution service could be augmented by either a video clip, streaming video or animated frame in another frame or window. For example, information on automobile loans could be displayed with video clips showing various new cars. The marketing software presentation will allow the financial institution to reinforce its name and logo with drive-up customers. Examples of typical screen shots are shown in FIGS. 6-12. Using this invention, a financial institution will be able to repeatedly communicate its mission statement, promote products and services.

The marketing consultant delivers a CD-ROM, DVD or via internet connections based on predetermined schedule (80) containing the marketing software presentation (100).

A financial institution will have the option to edit selected screens to update as often as they want. Up to 15% of screens are editable (90). This could be done using widely available business graphics software such as Microsoft Publisher This process affords the financial institution the flexibility of determining its level of involvement. It could range from high involvement to the marketing consultant providing a turnkey marketing and advertising solution.

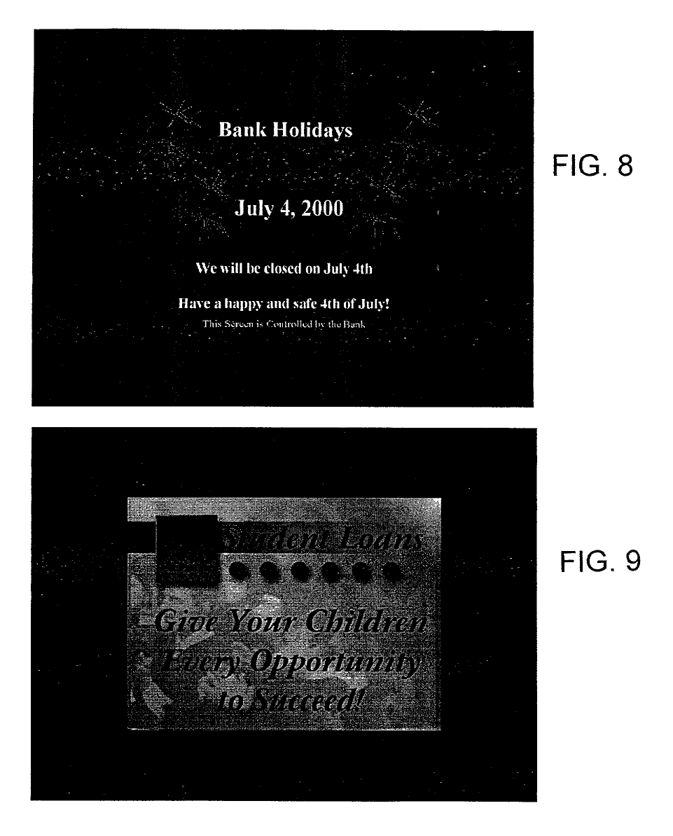

Examples of the information that a financial institution may want to include in its message to drive-up customers include; recognize new officers or personal bankers, promote bank events, an open house, new products/specials, banking hours or ATM locations. The bank may also desire to sell advertising space to realtors, retailers or professional service firms. The bank may want to recognize customers, businesses or bank sponsored events. The bank may want to provide space for community events, achievements or other items of local interest. Examples of typical screen shots that a financial institution might prepare to supplement the marketing software presentation are shown in FIGS. 7 and 8.

The marketing software presentation (100) will generally reside on a personal computer workstation (PC) located inside the financial institution (200). The PC (200) would be equipped with hardware technology that can support multiple monitors simultaneously. The PC would have an operating system such as Microsoft Windows™ and the appropriate graphics display driver to run the marketing software presentation. The software can run from the PC's hard drive, CD-ROM, or via an Internet connection with broadcast capabilities. The marketing software presentation is customized software for each financial institution. The software will typically be licensed to the end-user. The marketing consultant will typically require that the customer will only use this software with the hardware provided. The periodic updates will be provided to the financial institution to maintain fresh marketing messages. The PC may have a line connection to the internet for updates, downloads, and broadcasting capabilities (120) which, in one embodiment could be incorporated into the message. The PC (200) may also be provided with a line connection to obtain cable TV, a satellite dish, or other content sources for other types of programming/viewing options (110). This would allow distribution of selected web sites and broadcast cable TV shows such as a headline or financial news program, the weather channel, or a stock ticker display being available in separate window of the kiosk display screen while the banks primary marketing messages are simultaneously being displayed on the same monitor. A CCTV and audio connections could also be provided to allow communications with the financial institution staff.

The PC (200) would be connected to a Local Area Network (LAN) (240) for displaying the video message on a monitor (210). The LAN could be one of any number of commercially available technologies including wireless LAN's. The LAN could also be provided with audio (220) and CCTV (230) capabilities if desired The LAN (240) would connect the PC (200) with the outdoor kiosks (300) located in the drive-up lanes. It is preferably that each drive-up lane has one kiosk (300). The LAN (240) could also be connected to indoor monitors located in high visibility traffic areas (400) if the financial institution desires to operate similar monitors inside their location to maximize their marketing and advertising efforts. All monitors would be displaying an identical message simultaneously from the PC (200). The finalized marketing software presentation would play for its duration and then start over at its beginning. A customer would of course only see the portion that happened to be playing when the customer was waiting at the drive-up lane.

The outdoor kiosk (300) consists of a LCD monitor enclosed in a weather protective enclosure. The kiosk could be either integral with or attached to the drive-up teller. It could also be located as an adjacent separate unit visible to customers in the drive-up lane. The kiosk may be a pedestal type shape with the monitor (310) mounted on the top. The kiosk may be constructed out of stainless steel. Various other types of materials and shapes that are suitable for outdoor use are also possible alternatives. The kiosk (300) would be provided with heating and cooling features to control the inside temperature for the LCD monitor. The monitor can be of a variety of sizes, however the most popular sizes are expected to be 12″ or 15″. A feature of the LCD monitor is that it is “direct-daylight readable”. The monitor (310) must be capable of showing both graphics and text displays to drive-up customers. A commercially available LCD monitor that can be used for this invention is the Model SH45 available from Computer Dynamics™.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A marketing and advertising system for a retail establishment consisting of;
a marketing software presentation, a computer, a drive-up lane and a monitor,
the monitor, in communication with the computer, would be positioned to be visible in daylight conditions to a customer in the drive-up lane of the retail establishment, and
the computer would relay the marketing software presentation to the monitor for displaying to the customer.

2. The marketing and advertising system of claim 1 in which the monitor is divided into a plurality of windows.

3. The marketing and advertising system of claim 1 in which the marketing software presentation is periodically updated by a marketing consultant.

4. The marketing and advertising system of claim 1 in which the marketing software presentation can be directly modified by the retail establishment.

5. The marketing and advertising system of claim 1 in which the marketing software presentation is from 3 to 7 minutes in length.

6. The marketing and advertising system of claim 2 in which the marketing software presentation includes a stock ticker display.

7. The marketing and advertising system of claim 2 that also includes an employee located in the retail establishment and a two-way closed circuit television for real-time communication between the customer and the employee.

8. The marketing and advertising system of claim 1 in which the marketing software presentation is also displayed inside the retail establishment.

9. The marketing and advertising system of claim 3 in which the marketing software presentation is updated through the internet.

10. A marketing and advertising system for a financial institution consisting of;
a marketing software presentation, a computer, a drive-up lane and a monitor,
the monitor, in communication with the computer, would be positioned to be visible in daylight conditions to a customer in the drive-up lane of the financial institution, and
the computer would relay the marketing software presentation to the monitor for displaying to the customer.

11. The marketing and advertising system of claim 10 in which the monitor is divided into a plurality of windows.

12. The marketing and advertising system of claim 10 in which the marketing software presentation is periodically updated by a marketing consultant.

13. The marketing and advertising system of claim 10 in which the marketing software presentation can be directly modified by the financial institution.

14. The marketing and advertising system of claim 10 in which the marketing software presentation is from 3 to 7 minutes in length.

15. The marketing and advertising system of claim 11 in which the marketing software presentation includes a stock ticker display.

16. The marketing and advertising system of claim 11 that also includes an employee located in the financial institution and a two-way closed circuit television for real-time communication between the customer and the employee.

17. The marketing and advertising system of claim 10 in which the marketing software presentation is also displayed inside the financial institution.

18. The marketing and advertising system of claim 10 that also includes an audio communications signal being broadcast in cooperation with the marketing software presentation.

19. The marketing and advertising system of claim 12 in which the marketing software presentation is updated through the internet.

20. A marketing and advertising system for a financial institution consisting of;
a marketing software presentation, a computer, a drive-up lane and a monitor,
the monitor, in communication with the computer, would be positioned to be visible in daylight conditions to a customer in the drive-up lane of the financial institution,
the computer would relay the marketing software presentation to the monitor for displaying to the customer,
the marketing software presentation would also be displayed inside the financial institution and would have a length in a range from 3 to 7 minutes,
the marketing software presentation would also be updated by a marketing consultant on a 30 to 90 day frequency, and
the financial institution would be able to directly modify from 0 to 15 percent of the marketing software presentation.
